(19) United States
(12) Patent Application Publication
(10) Pub. No.: US 2026/0163318 A1
(43) Pub. Date: Jun. 11, 2026

(54) MODULAR ELECTRICAL POWER SYSTEM

(71) Applicant: xTHOT LLC, Indianapolis, IN (US)

(72) Inventor: Christopher Michael TRESS, Indianapolis, IN (US)

(21) Appl. No.: 19/181,954

(22) Filed: Apr. 17, 2025

Related U.S. Application Data
(60) Provisional application No. 63/635,065, filed on Apr. 17, 2024.

(51) Int. Cl. H01R 25/14; H01R 13/10; H01R 13/22; H01R 13/627; H01R 13/631; H01R 13/713; H01R 103/00

(52) U.S. Cl. CPC H01R 25/142; H01R 13/10; H01R 13/22; H01R 13/6272; H01R 13/6315; H01R 13/7135; H01R 25/145; H01R 2103/00

(57) ABSTRACT

Modular and/or tracked electrical power systems are provided. A tracked power system includes a power rail to which power receptacles may be attached thereto. A GFCI module may be used in connection with the power rail.

### CROSS REFERENCE(S) TO RELATED APPLICATION(S)

This application claims priority to U.S. Provisional Application No. 63/635,065, filed Apr. 17, 2024, the entire contents of which are hereby incorporated by reference.

### TECHNICAL OVERVIEW

The technology described herein relates to modular or tracked electrical power systems. More particularly, the technology described herein relates to tracked electrical power strips to which multiple receptacles (e.g., electrical plugs and the like) can be attached. The tracked power strip can also engage with a GFCI module.

### INTRODUCTION

Power outlets are traditionally located in fixed locations to provide power for a variety of purposes. Tracked lighting and/or power systems can allow for more flexible placement.

However, an issue with tracked power systems can be designing a system that facilitates ease of module attachment, while also having those modules be securely attached (e.g., so as not to short out). Unlike tracked lighting systems, tracked power systems may support increased user interactions with any or all of the attached power receptacles. Unlike tracked lighting systems, users of tracked power systems may plug and unplug various devices (smart devices, lights, etc.) to a power module located in a tracked system many times during a week or even during a given day. Each of these interactions may cause some level of force to be applied to the power modules, which may lead to the power modules becoming dislodged or the like from the track.

Accordingly, additional work is still needed in the area of electrical power systems that allow for modular placement of power plugs and the like. Accordingly, it will be appreciated that new and improved techniques, systems, and processes are continually sought after.

### SUMMARY

In certain example embodiments, a modular or tracked electrical power system is provided. The power system includes a power rail and at least one power receptacle. The power receptacle includes a main body and an arm that is configured to be placed into a slot of the power rail. In certain example embodiments, a GFCI module may be attached to the power rail (or multiple power rails.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1A shows a perspective view of a tracked power system according to certain example embodiments;

FIG. 1B shows an alternative arrangement of the tracked power system of FIG. 1A according to certain example embodiments;

FIG. 2A is a perspective view of an end of a power strip from the system shown in FIG. 1A according to certain example embodiments;

FIG. 2B is a cross-sectional view of the power strip from the system shown in FIG. 1A according to certain example embodiments;

FIG. 3A is a front perspective view of a power receptacle from the tracked power system shown in FIG. 1A according to certain example embodiments;

FIG. 3B is a rear view of the power receptacle shown in FIG. 3A according to certain example embodiments;

FIG. 3C is an angled side view of the power receptacle shown in FIG. 3A according to certain example embodiments;

FIG. 3D is a rear perspective view of the power receptacle shown in FIG. 3A according to certain example embodiments;

FIG. 4A is a side view illustrating an example power receptacle slotted into an example power strip with a locking hook of the power receptacle engaged with the power strip according to certain example embodiments;

FIG. 4B is another side view illustrating the example power receptacle slotted into the example power strip of FIG. 4A with the locking hook of the power receptacle disengaged from the power strip according to certain example embodiments;

FIG. 4C is another side view illustrating the example power receptacle slotted into the example power strip of FIG. 4A with a cover engaged over the arm of the power receptacle according to certain example embodiments;

FIG. 5 is an exploded view of the GFCI module shown in FIG. 1 and a bracket that can be used to couple the GFCI module to a power strip according to certain example embodiments;

FIG. 6 is a perspective view of the GFCI module shown in FIG. 5 according to certain example embodiments;

FIG. 7 is a perspective view of the bracket used to mount the GFCI module of FIG. 6 to a power strip according to certain example embodiments;

FIG. 8A shows a front view of an angled power receptacle according to certain example embodiments;

FIG. 8B is a side view of the power receptacle shown in FIG. 8A;

FIG. 9 is a side view showing an example dust cover according to certain example embodiments;

FIGS. 10A and 10B are side views of another example of a locking element according to certain example embodiments;

FIG. 11A is a side view of another example of a GFCI module according to certain example embodiments;

FIG. 11B is a rear view and

FIG. 11C is a rear-perspective view of the GFCI module shown in FIG. 11A;

FIG. 12A is a front view showing an example bracket connected to an example power strip according to certain example embodiments;

FIG. 12B is a perspective view of FIG. 12A;

FIG. 13 is a rear view showing the example GFCI module from FIG. 11B connected to a power strip according to certain example embodiments; and

FIG. 14 shows a perspective view of the example GFCI module from FIG. 11A in combination with the bracket and power strip from FIG. 12A according to certain example embodiments.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

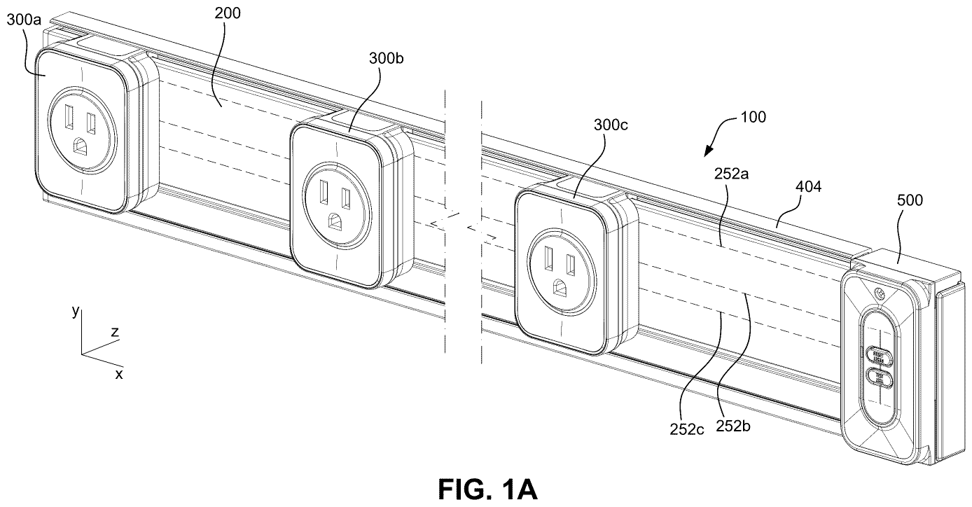

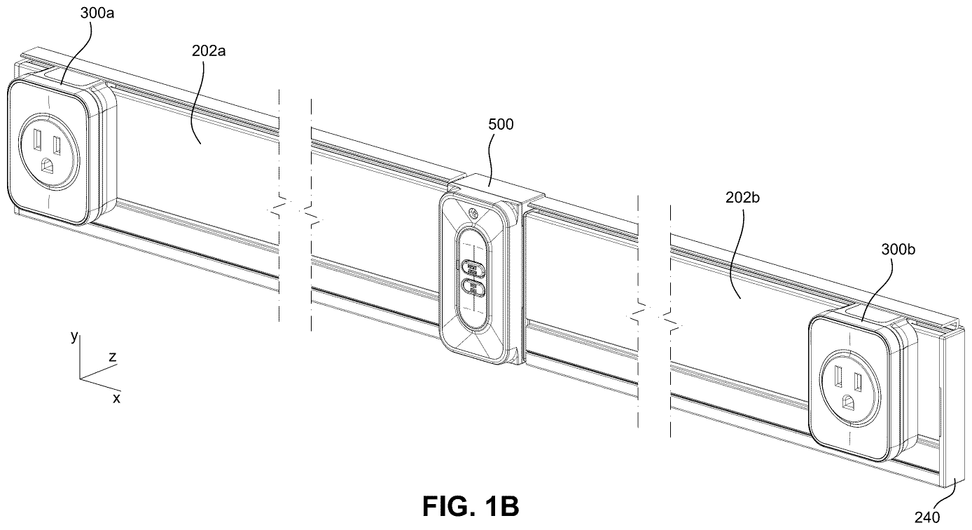

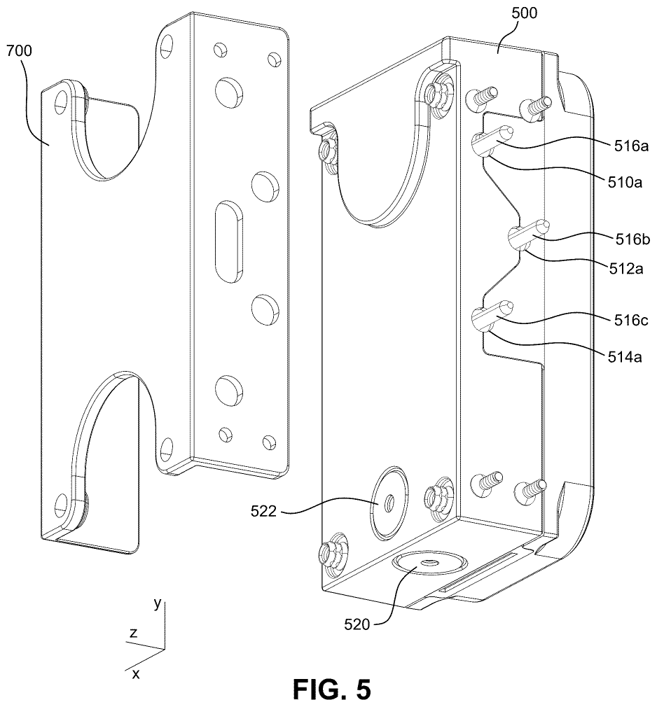

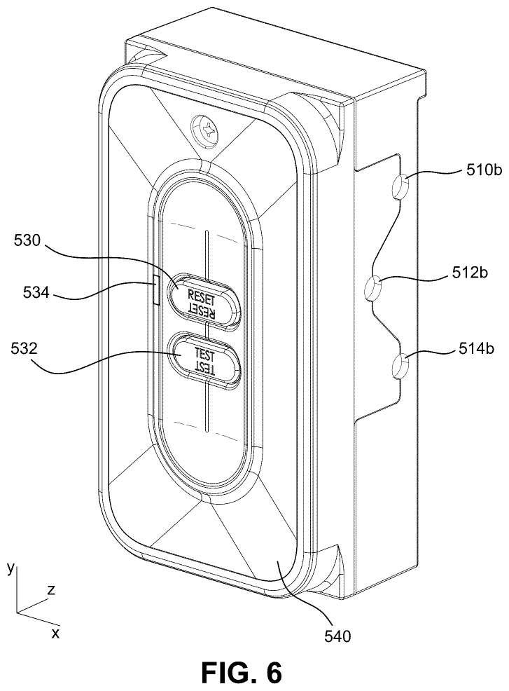

Some reference numbers are reused across multiple Figures to the same element. For example, as discussed below, the GFCI module 500 is shown in FIG. 1 and then also discussed in connections with FIGS. 5 and 6. Other elements may be similarly referenced across the various figures herein.

### Description of FIGS. 1A-1B: Power System

FIG. 1A shows a perspective view of a tracked power system 100 according to certain example embodiments. An alternative arrangement for the tracked power system 100 is shown in FIG. 1B according to certain example embodiments.

The tracked power system 100 includes a power strip 200 (which may also be called a power rail herein) to which one more power receptacles 300 (300A, 300B, 300C) may be disposed. The power strip 200 may electrically connect to a ground-fault circuit interrupter module (GFCI) 500.

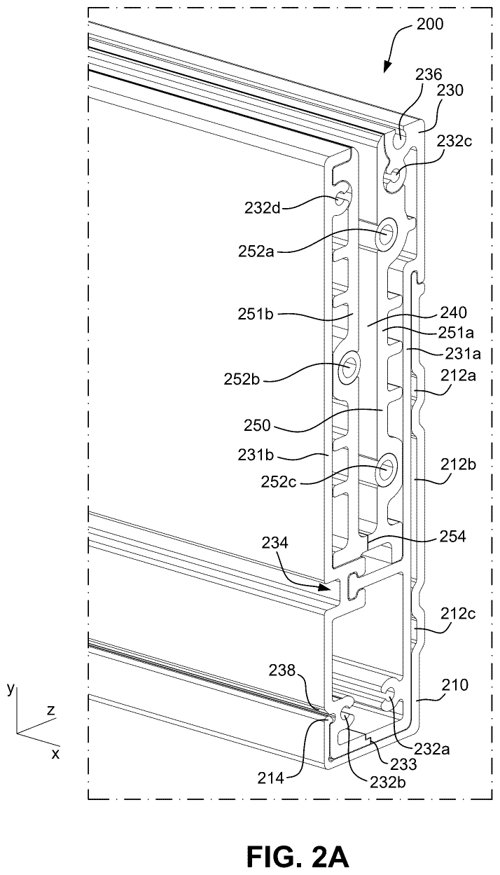

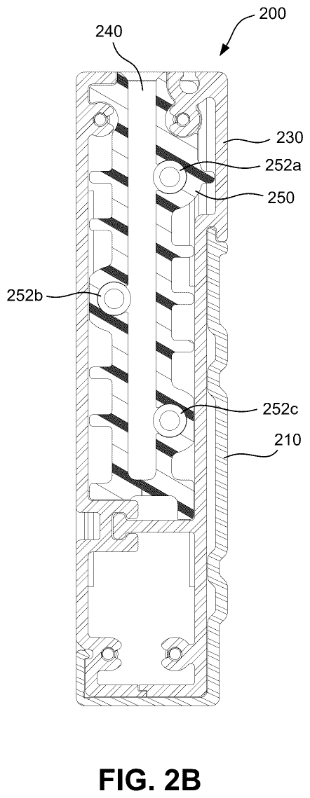

Included in the power strip 200 are one or more (e.g., three) electrical conductors 252a, 252b, and 252c (e.g., hot, neutral, and ground) that are used to provided power along the length (in the longitudinal direction) of the power strip 200 and to power receptacles disposed thereon. The electrical conductors may be solid wires and/or may be hollow (e.g., as shown in FIG. 2A). Electrical power may be provided via the GFCI module 500 that is electrically connected to the conductors in the power strip.

Note that while the examples shown in FIGS. 1A and 1B are for AC power, that the techniques described herein may also be adapted for systems that supply DC power. In a DC power example, the power system may include a receptacle and a power strip and be connected to a DC power source (and not make use of a GFCI module). In certain example embodiments, additional wires, cables, or the like may be provided within the power strip. For example, data cables may (e.g., category 1 through 8—or above) may be included in the power strip. Accordingly, in certain example embodiments, the power strip may be used to provide both data and power.

In certain example embodiments, the conductors included in the power strip may extend from one end of the power strip to the other. The conductors may extend in a straight light from two points and/or may bend/curve between the two points. For example, conductors 252a, 252b, and/or 252c may bend in a serpentine like manner along the length of the slot 240. In some examples, one conductor (e.g., 252b) may bend while the other two conductors along the opposite wall of the slot 240 are straight.

In certain example embodiments, when engaged with the power rail, the power receptacle is positioned below/inferior to the top/superior surface of the power rail. In certain example embodiments, when a power receptacle is engaged with the power the power receptacle is positioned above/superior to the bottom/inferior surface of the rail (opposite where slot opening is located engaged with the power rail.

In certain example embodiments, and as shown in FIG. 1A, the GFCI module 500 may be positioned at one end of the power strip. In an alternative arrangement, as shown in FIG. 1B, the GFCI module 500 may be positioned between two separate sections of power strip 200. Specifically, a first power strip 202A section may be electrically connected to one side of the GFCI module 500 and a second power strip 202B may be electrically connected to the other side of the GFCI module 500. Power may be provided from an external source and then distributed along the length of both power strips 202A/202B to provide power to receptacles (300A/300B) disposed on the respective power strip.

Termination at the end of the power strip may be provided via a GFCI module 500 (as shown in FIG. 1A). Alternatively, an end cap 240 may be disposed over the end of the power strip 200 (at an end of 202B in FIG. 1B). The end cap 240 may cover the internal components of the power strip 200 (as discussed in connection with FIGS. 2A-2B).

The length of the power strip 200 may be different depending on one or more different design considerations. For example, a power strip 200 may be provided along the entire length of a wall in a kitchen or the like. Each separate installation of a power strip (which may each be connected to electrical power via a corresponding GFCI module) may support multiple different power receptacles. As an illustrative example, the power system 100 may be electrically connected to a 20 A circuit and accordingly each power module may be rated up to 20 A. In such an example, the power system may provide up to about 2200 watts. In the case of a 15 A circuit, then the total wattage would be about 1800 watts for the one or more power receptacles disposed in the power strip.

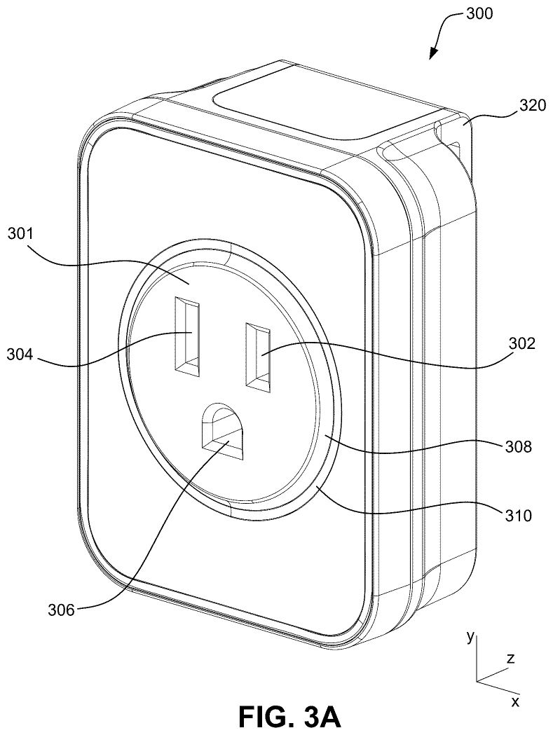

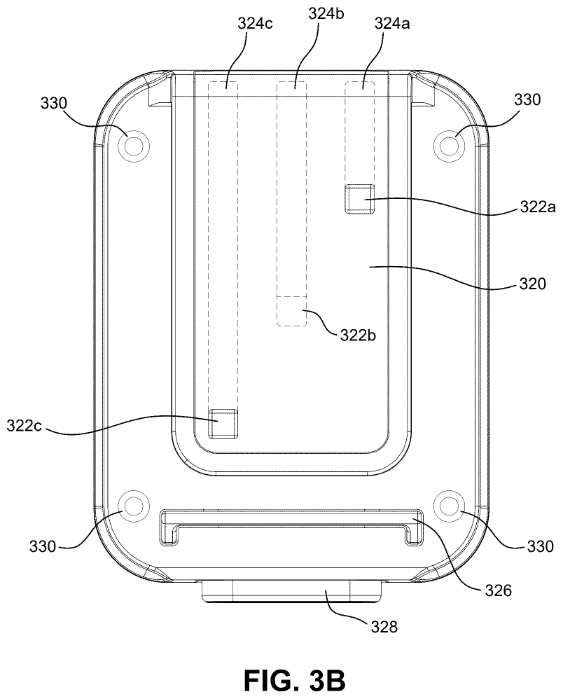

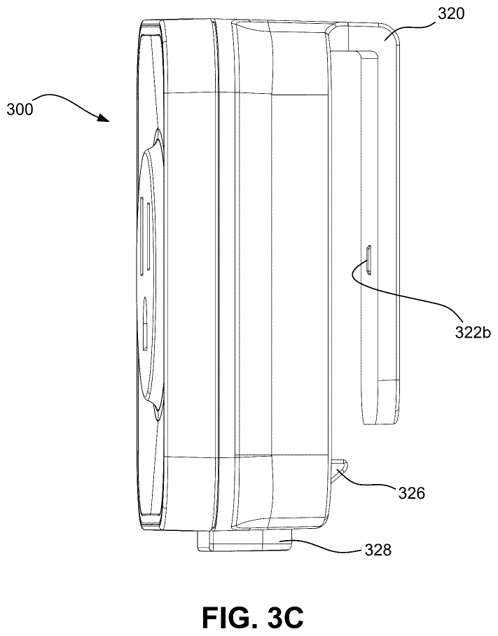

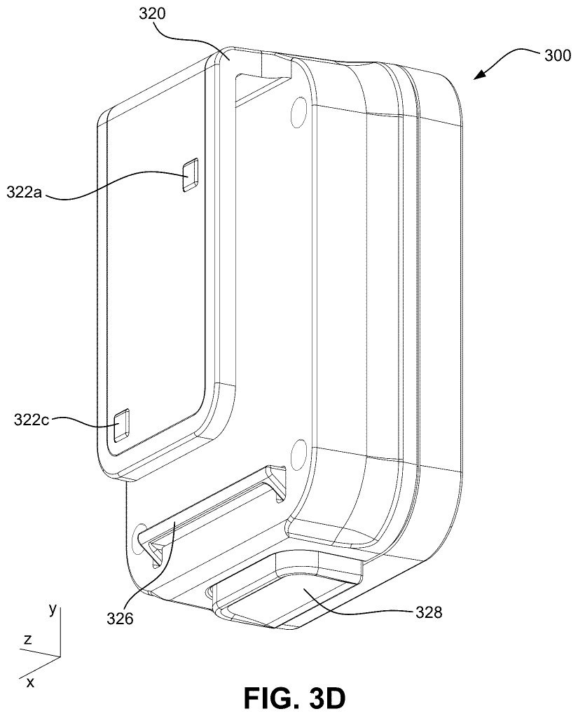

While the power receptacles discussed herein are discussed in connection with an example three-pronged power connection that other connections may be provided in an example “power” receptacle. For example, a receptacle that includes a USB-A plug, a USB-C plug, or the like may be provided. Different types of receptacles may be connected to the same power strip. For example, a three-pronged power receptacle, a USB-A receptacle, and a USB-C receptacle may each be disposed at different positions along the same power strip. In some examples, receptacles that provide differing electrical standards (e.g., EU and the like) may also be provided. In another example, a power receptacle may be provided for wireless charging. A power receptacle that provides wireless charging may have a flat face and sit either perpendicular to the track (e.g., a shelf) after pushing it in or slightly angled down to wirelessly charge a phone or other applicant (e.g., a smart watch, etc.). The device that is to be charged may thus rest on or against the power receptacle that is providing wireless power. In certain example embodiments, a power receptacle may include a transformer to reduce power to 24V or another voltage (e.g., from 120V). Such a power receptacle may allow for further modules to connect thereto (e.g., a 12V device, such as a night light, clock, or other device). As another example, a power receptacle may include an internal transformer that converts the 120 VAC to 5 VDC. This may then be used for supplying power via a USB-A or USB-C outlet to devices that can run on 5 VDC. In certain example embodiments, an example power receptacle may include such an internal transformer that converts the 120 VAC to 5 VDCpower and additional provides power to a standard 120 VAC outlet (e.g., as shown at 301 in FIG. 3A). Accordingly, the same power receptacle may provide two or more sockets for different types of plugs (e.g., a standard 3-prong AC plug in addition to a USB-A and/or USB-C plug).

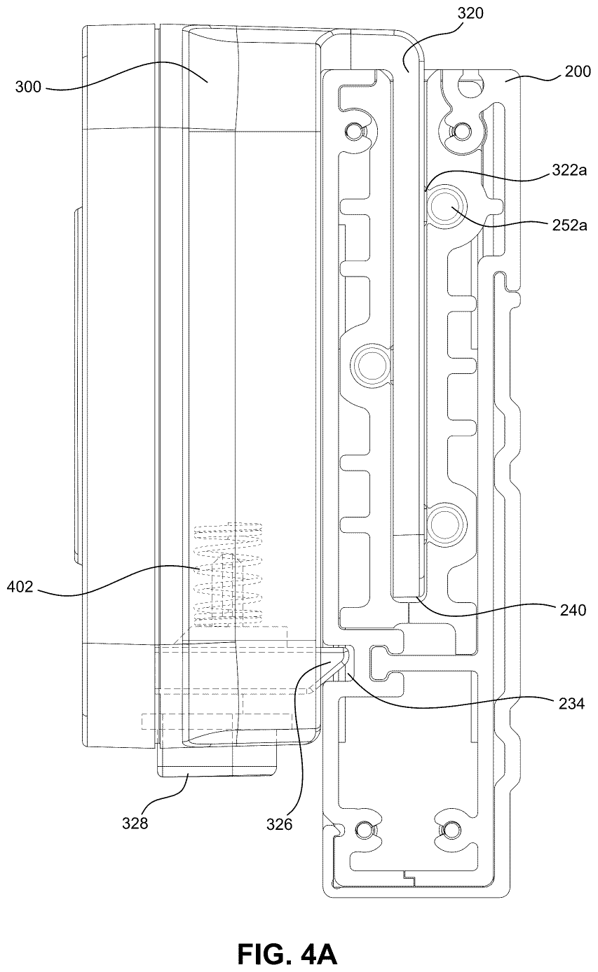

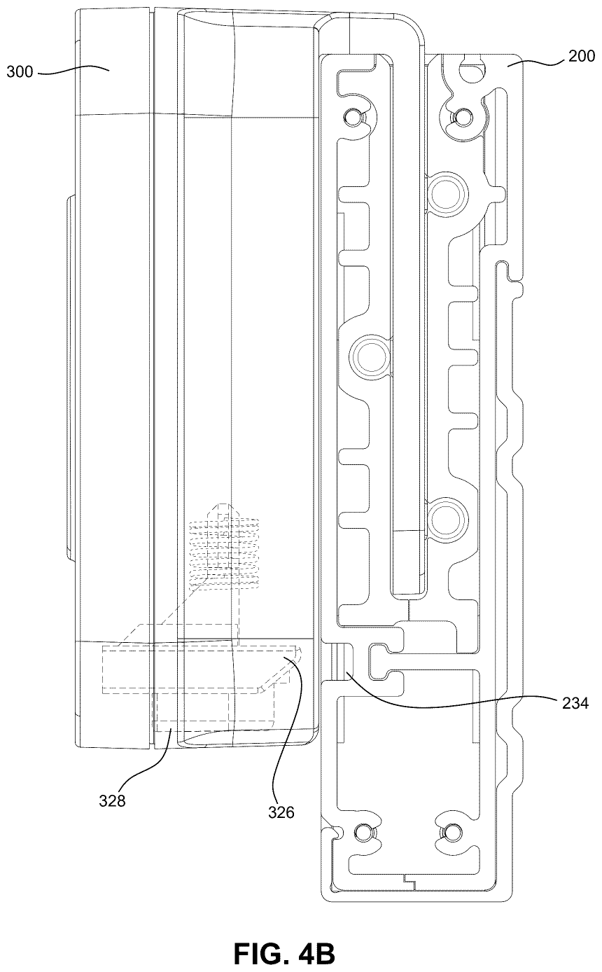

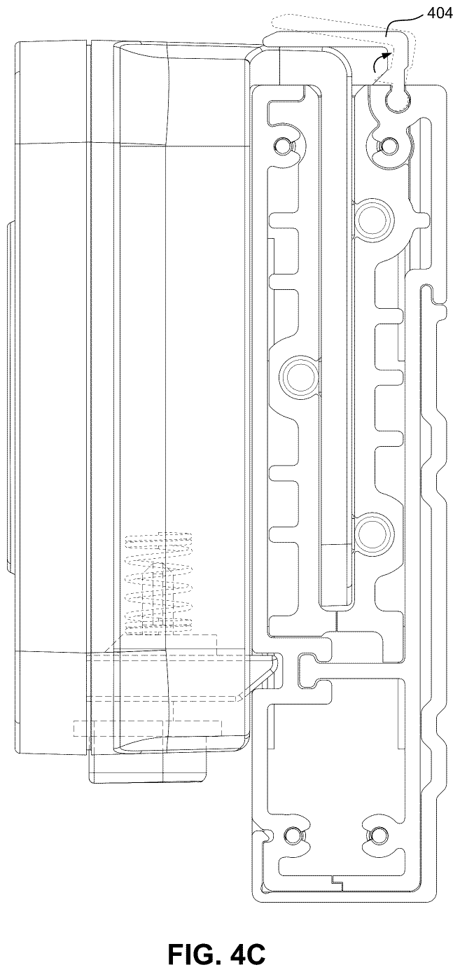

Additional details of the power strip 200 are provided in connection with FIGS. 2A-2B. Additional details of power receptacle 300 (300A/300B/300C) are provided in connection with FIGS. 3A-4C. And additional details of GFCI module 500 are provided in FIGS. 5-7.

In connection with the discussion of the drawings provided herein, unless otherwise noted, widthwise or width refers to the axis along the longitudinal axis of the power strip (e.g., from the position of the power strip which 300a is located to the position at the power strip 200 which 300b is located). The width or longitudinal axis corresponds to the X axis herein as well. Height refers to an axis transverse to width and from the bottom (e.g., where 233 is located in FIG. 2A) to the top of the power strip (e.g., where channel 236 is located). Height corresponds to the Y axis herein as well. Depth herein refers to the axis that is traverse to both the above noted height and width axis and corresponds to the axis from the front of the power strip (e.g., where channel 234 is locate) to the back of the power strip (e.g., where wall bracket 210 is mounted to a wall or the like) and corresponds to the Z axis. Orientations with reference to the power receptacle and GFCI module use the same orientations as if those modules were connected to the power strip (as shown in FIGS. 1A and 1B). Terms such as left/right are used with reference to relative positioning along the X axis. Terms such as front/back are used with reference to relative positioning along the Z axis. And terms such as above/below are used with reference to relative positioning along the Y axis.

### Description of FIGS. 2A-2B: Power Strip

FIGS. 2A-2B are example views of the power strip 200 from the system 100 shown in FIG. 1. FIG. 2A is a perspective view of an end of the power strip 200 and FIG. 2B is a cross-sectional view of the power strip 200 from the system 100 according to certain example embodiments. The following descriptions refers to both FIGS. 2A and 2B as well as FIG. 1A-1B.

Power strip 200 can extend in varying lengths in a longitudinal direction and generally permits lateral movement of an attached power receptacle. Note that while the power receptacle is engaged as described herein, it may remain in electrical contact with the power strip as it is being moved laterally.

Power strip 200 includes an inner housing element 250 that is disposed within an outer housing element 230. The outer housing element 230 may then be disposed within wall bracket 210 and is designed to hold the outer housing element (e.g., without the use of screws or the like).

As shown in FIG. 2A, outer housing element 230 is composed of two separate housing elements, 231A and 231B, that lock together via grove 233. It will be appreciated, however, that the outer housing element 230 may be formed of one continuous structural piece, or three or more separate pieces.

Outer housing element 230 includes a plurality of screw holes 232a, 232b, 232c, and 232d. These may be configured to match screw locations in GFCI module 500 and/or an end plate that may be positioned over the end of power strip. In other words, an example end plate may be used to cover the internal structure of power strip 200 (as shown in FIG. 2A). In certain examples an end cap may then be placed over the end plate to thereby hide the screws that may be exposed on the outer side of the end plate. The end cap may be configured to snap over the end of the power strip and end plate and may be held in place with friction or the like.

Outer housing element 230 also defines a notch 238 in which the wall bracket 210 may be secured via end 214. A locking channel 234 is defined by the outer housing element 230. The locking channel allows a locking element from a receptacle 300 to engage therewith (discussed in greater detail in FIGS. 4A and 4B),

The outer housing element 230 may be disposed into wall bracket 210. More specifically, wall bracket 210 may be affixed to a wall, under countertop, or the like. The wall bracket 210 may be affixed to a wall by using screws or the like via any/all of divots 212a, 212b, and 212c. The extruded design of the wall bracket 210 allows portions thereof to remain flush against the outer housing element 230 when the outer housing element 230 is disposed into the wall bracket 210. In other words, the rear surface (back surface or wall facing surface) of the housing element is arranged to contact with the wall bracket 210 while the bottom surface rests in the bottom of the wall bracket 210. The arrangement of the wall bracket 210 and outer housing element 230 can allow for an easier installation of the power system as the wall bracket 210 may be first affixed using screws, nails, or the like. Once affixed, the wall bracket 210 may be used to structurally secure (e.g., via friction) the outer housing element 230 in use.

Located in the outer housing element 230 is an inner housing element 250. Similar to the outer housing element 230, the inner housing element 250 may be formed out of first and second inner housing elements 251a, and 251b that engage with one another at 254.

The inner housing element 250 may also be formed out of 1 continuous structural piece, or 3 or more pieces that are fitted together inside the outer housing element.

The inner housing element 250 defines a slot 240 into which an arm of a receptacle may be located.

Inner housing element 250 includes three electrical conductors: first conductor 252a, second conductor 252b, and third conductor 252c. These may be hot, neutral, and ground conductors. Each of these is structured to electrically contact the contact points of a corresponding receptacle to thereby provide power to the receptacle. Power to the electrical conductor may be provided via GFCI module 500 that is coupled to (e.g., hardwired) to an external power source in a residential environment. In certain example embodiments, two conductors are provided along the same or opposing side walls of the inner housing element 250 and a third is provided along a bottom of slot 240 (e.g., at or near 254). The third conductor that is provided along the bottom of slot 240 may be the hot, ground, or neutral wire.

In certain example embodiments, the electrical conductors may have a hollow inner portion (as shown in FIG. 2A), which may facilitate head dissipation. In other examples, the conductors may be solid. In certain examples, the ends of the electrical conductors (e.g., 3 to 6 inches from an end of a corresponding power strip) may be formed with a hollow inner portion while the interior arrangement of the electrical conductors may be solid. The hollow portion may facilitate using a connector (e.g., a male-to-male connector) to allow for easier connection of other electrical elements, such as additional power strips and/or the GFCI module described in connection with the embodiments herein (e.g., as discussed in connection with FIG. 5-7 or 11A-14). In some examples, the electrical conductors may be referred to as wires, bus bars, or similar.

In certain example embodiments multiple different power strips may be connected to one another. In some examples, the connections between power strips may form right angles to allow the strips to run along perpendicular walls or the like, for example.

As shown in FIG. 2A, two of the three electrical conductors(e.g., 252a and 252c) are located along the same side (e.g., the same side wall) of the defined slot 240, while a third electrical element (e.g., 252b) is located on an opposing side (e.g., an opposite side wall) of slot 240. This type of arrangement can be a technical advantage over placing all of the electrical elements on the same side. This type of arrangement can tend to decrease the (e.g., accidental) chance of shorting out the electrical connection provided by system 100. This is because inserting/removing a power receptacle at an angle or the like (e.g., not generally straight into slot 240) and accidentally causing two different contacts of a receptacle to electrically contact the same electrical conductor 252a/252b/252c) may cause a short circuit. Accordingly, by increasing the distance between the two closest contacts (e.g., by moving one to an opposing side wall in the slot 240) the chances of causing (e.g., accidentally) a short circuit may be further decreased.

Outer housing element 230 and bracket may be formed out of a metal element (e.g., aluminum or the like) or other material. Inner housing element 250 may be formed out of plastic (e.g., ABS), with the interior electrical elements formed out of an electrically conductive metal, such as copper or brass. The ABS may electrically isolate each of the electrical elements from other conductive material.

FIG. 2B shows a cross section of the power strip looking down along the longitudinal axis thereof. The outer circumferential surface (e.g., the perimeter) of the power strip 200 includes a gap where the power receptacle 300 is slotted (into channel 240) and a gap where lock 326 is slotted (into channel 234). Accordingly, the gap for channel 234 may be along a major surface (e.g., a front surface, a front face, or an exposed surface) of the power strip 200 while the gap for slot 240 is along a minor surface (e.g., the upper surface).

The gap to channel 234 may be less than half the depth of the upper surface of the power strip 200 in certain examples. The gap to channel 234 may be less than a quarter of the width of the upper surface in certain examples.

Channel 234 is arranged below the maximum extent that the arm of 320 of the power receptacle may be inserted into slot 240. In other words, the bottom of slot 240 is located above the location of the channel 234. However, in other examples, the channel 234 and slot 240 may be arranged differently - e.g., (234 located between the top of the slot 240 and the bottom of slot 240). In certain examples 234 and 240 may both be referred to as slots or both referred to as channels. For example, the structure shown at 234 may be a first channel and the structure shown at 240 may be a second channel (or vice versa).

Channel 234 and slot 240 may be arranged traverse to one another. In other words, when a structure is inserted thereto (e.g. arm 320 or lock 326) the direction of insertion of the two structures is transverse and not parallel or along the same plane.

The power strip 200 shown in FIGS. 2A and 2B includes three primary components, each having one or more attributes. While three components are described in connection with the non-limiting example of power strip 200, it will be appreciated that other examples may have a differing number of primary components. For example, a power strip may be manufactured using a single component that defines one or more of the structure aspects as discussed herein. It will also be appreciated that one or more of the internal structural aspects of the power strip may be adjusted. For example, the bottom half of the outer housing element 230 (below where the inner housing element 250 is located) may be adjusted or filled in (e.g., completely solid).

### Description of FIGS. 3A-4C: Power Receptacle

FIG. 3A is a front perspective view of a power receptacle from the tracked power system shown in FIG. 1A. FIG. 3B is a rear view, FIG. 3C is an angled side view, and FIG. 3D is a rear perspective view. FIGS. 4A-4C show side views illustrating interaction of an example power receptacle with a power strip.

Receptacle 300 includes a main body 315 and an arm 320.

On the main body 315 is a socket 301 with three cavities (302, 304, and 306) that respectively host electrical contacts for hot, neutral, and ground. These are each electrically connected (via conductors 324a, 324b, and 324c) to a corresponding one of the electrical contacts 322a, 322b, and 322c disposed in arm of the receptacle 300.

Extruded area 308 of socket 301 is used to raise the socket 301 away from the rest of the front of the receptacle (as illustrated in FIG. 3C). A circular light 310 (e.g., an LED or the like) may be disposed around the circular socket 301 and configured to illuminate when the receptacle 300 is electrically connected to a power source via the power strip 200. In certain examples, an example receptacle may not include a circular light and/or may not have an extruded area 308. Rather, the socket portion of the receptacle may be flush with the rest of the front of the receptacle.

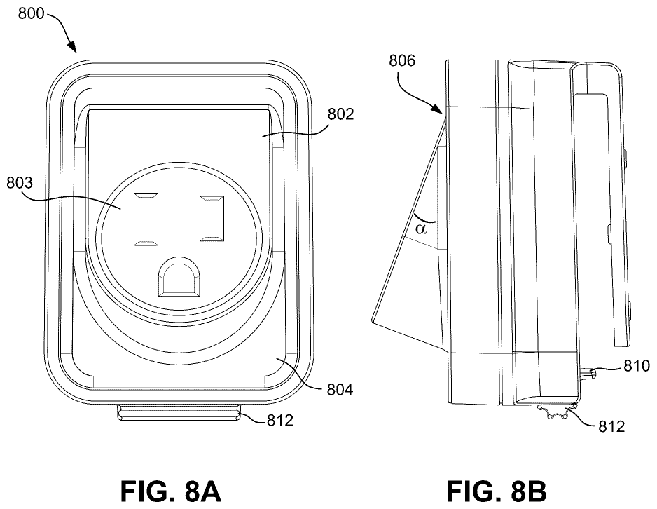

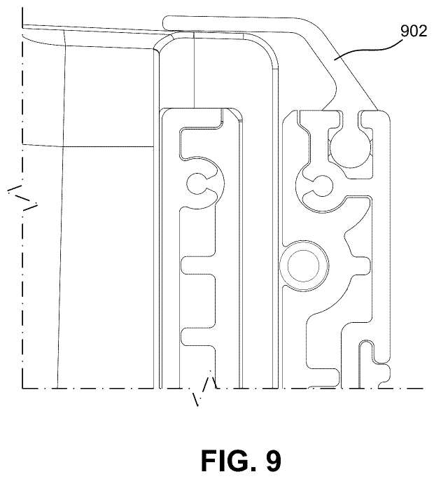

In certain example embodiments, the face on which the socket 301 is located may be parallel to the orientation of any of the power receptacle or the arm thereof. Accordingly, a person that is plugging a cord or the like into the socket will engage with the socket at or about a 90 degrees (e.g., the surface normal of the face of the socket). However, in other examples, the socket 301 may be formed at an angle of the receptacle. For example, the socket 301 may be angled between 1 and 5 degrees, between 5 and 10 degrees, between 10 and 15 degrees, and up to, for example, about 30 degrees. FIGS. 8A and 8B, discussed below, show an example of a power receptacle with an angled socket. When the socket is angled to such a degree one side of the extruded area 308 may be raised higher than another to allow the socket 301 to be angled with respect to the front of the receptacle.

As noted herein, other types of sockets may be used in certain examples, thus the socket that is provided for a receptacle may include support a USB-A connection, a USB-C connection, or other type of electrical connection that may be used to supply power.

In certain example embodiments, a switch may be included on a side (or elsewhere) of the receptacle in order to control whether light 310 is illuminated or not. In some examples, light 310 may be turned on (e.g., automatically) when no plug is connected to the socket. When a plug is plugged into the socket, the light 310 may be turned off (e.g., automatically).

Arm 320 allows the power receptacle to be slotted into an example power strip (200). In certain examples, the arm 320 of the receptacle is provided as a single manufactured element. In other examples, the arm 320 may be latched to the rest of the body of the receptacle (e.g., via using screws, friction or the like). An advantage of the arm being formed with the main body 315 (e.g., part of a single mold) of the receptacle is that the strength of the connection of the arm to the rest of the body may be relatively increased.

The arm may be greater than 50 percent of the width of the power receptacle and may be greater than about 75 or 80 percent of the width of the power receptacle. While using 100 percent of the width of the power receptacle may be advantageous in certain examples, using less than 100 percent of the width for the arm can allow for the sides of the power receptacle to be tapered to allow easier manipulation by a user and insertion of the into power receptacle the slot of the power strip. In certain examples, the arm may be composed of multiple prongs, which may correspond to the electrical connections between each of the electrical contacts thereon and the power socket on the front face. Thus, for example, the arm may be composed of three separate fingers (which may each correspond to 324a, 324b, and 324c.

On the back side (e.g., the outer surface) of the arm 320, two electrical contacts: 322a and 322c may be disposed. On a front side (e.g., the inner surface) of the arm 320, a third electrical contact, 322b, may be disposed. Each of the electrical contacts may be formed out of copper, brass, or other electrically conductive material. Each of the electrical contacts may slightly bump out from the surface of the arm.

In certain example embodiments, the contacts of the power receptacle are spaced evenly in both a longitudinal direction and in a vertical direction.

In some embodiments, two electrical contacts may be provided on the inner surface of the arm (e.g., the same longitudinal plane), while one is provided on the outer surface. In some examples, all three electrical contacts may be provided on the outer surface or the inner surface. In some examples, only two electrical contacts may be used (e.g., for hot/neutral without having a ground).

In certain example embodiments, all three electrical contacts are equidistant. In such an embodiment, the distance between the electrical contacts may match the distance between the electrical conductors in a power strip. For example, the distance between the top contact and middle contact is X, and the distance between the middle contact and the bottom contact is also X. In certain examples, such equidistant separation is provided along one axis (e.g., vertically), while the distance in another direction (e.g., laterally) is not equidistant.

Various different locations of the electrical contacts on the arm may be adopted in connection with various embodiments. For example, two of the contacts may be located on the inner (or outer) surface of the arm and a third may be located along the bottom section of the arm to allow for electrical connection to an electrical conductor that is positioned along the bottom of slot 240 (e.g., at or near 254). In another example, one contact on an outer surface of the arm, a second on an inner surface, and a third along the bottom.

Note that the arrangement of the contacts in a dispersed horizontal direction allows for greater distancing of, for example, contact 322a from contact 322c and further reducing the likelihood of two contacts contacting the same conductor of the power strip. The shown and described arrangement of contacts accordingly can allow for some twisting or angling of the receptacle, while preventing shorts of the electrical connection.

Included on the back side of the receptacle are a plurality of screw holes 330 that may be used to affix a front part of the receptacle to a rear part (and to access the inside of the receptacle).

Referring now also to FIGS. 4A-4C, the arm 320 of the receptacle 300 is configured to slot into slot 240. When fully inserted each of the electrical contacts of the arm will electrically connect with a corresponding conductor of 252a, 252b, and 252c. The electrical connection between conductors 252a-252c, to contacts 322a-322c, and to socket 301 thus can provide power to a connected device.

In certain example embodiments, the socket 301 can be aligned (e.g., within the same height as) the slot within the power strip.

Receptacle 300 also includes a locking element 326 that is configured to engage with locking channel 234 of the power strip 200. The locking element 326 is mechanically connected to button 328 and spring 402 that is disposed inside of the receptacle. In a default state (as shown in FIG. 4A), the locking element 326 is forced, by the spring 402, out away from the back face of the receptacle. Depressing the button 328 causes the spring to contract and allows the locking element 326 to retract (as shown in FIG. 4B) into the body of the receptacle.

In certain example embodiments, the power receptacle includes a button that is configured to, when actuated, the at least one protrusion to move between the extended and retracted positions. In certain example embodiments, the button is positioned on a surface of the power receptacle that is transverse to the front face that includes the electrical socket.

As shown in FIG. 3B, the locking element 326 is a continuous structure that extends the majority of the back surface of the power receptacle and is wider than the width of the arm 320. In other examples, different configurations for the locking element 326 may be provided. For example, the locking element may comprise a plurality of teeth or other indentations that move in a manner that is the same as locking element 326 or similar. Such teeth may engage with the locking channel 234. Accordingly, one or more protrusions may be used as the locking element 326 according to certain example embodiments.

In an alternative arrangement the structure of lock 326 and channel 234 may be switched such the channel is provided in the power receptacle while the protrusion is provided on the power strip 200.

Other types of structures may also be used to have the receptacle lock or engage with the power strip in addition to the arm / slot engagement. For example, each of the power receptacle and power rail can include one or more housings that are structured to inface with one another (e.g. similar to how a door lock or a deadbolt operates). In certain examples, the button 328 (or other similar structure) may be used to actuate or free the additional structure to thereby allow for removal of the power receptacle from electrical contact with the power strip.

In certain examples spring 402 may be provided to act against an interior wall that forces the energy from the spring (be default) in a downward direction towards the button 328. This force pushes both the button and the locking element out away from the receptacle.

In certain example embodiments, two springs may be provided that are disposed on either side of the button. This may allow for a more even distribution of force over the width of the button as the button is being depressed.

The locking element 326 provides an additional level of structural stability for placement of the receptacle in the power strip. This helps prevents, for example, a person from potentially pulling on the receptacle (e.g., if a cord is plugged into the socket) and possibly dislodging the receptacle or otherwise moving it.

It will be appreciated that in other implementations, different types of locking elements are contemplated. The locking element shown in FIG. 4A uses friction with the surface of the locking channel to prevent additional movement. In other situations, a hook or the like may be used as part of the locking element. For example, a hook or a latch from the locking element may be used to engage with a notch/nub or other structural element of the locking channel to provide yet further structural stability to the positioning of the receptacle on the power strip.

In another example, the power receptacle may include structure configured to “buckle” into the channel. For example, the power receptacle may slide into power strip, after which a person may press the structure on the back of the power receptacle into the channel (e.g., snap into place). Such an embodiment would use friction to secure the power receptacle to the power strip (e.g., without including moving parts into the power receptacle). For example, the power receptacle may include one or more protrusions on the back that are configured to be pushed into and engage with the channel of the power strip.

It will be appreciated that in other implementations, different types of buttons or the like may be used to engage and retract the locking element. For example, a slide that is mechanically connected to the locking element may be used to cause the locking element to slide into the locking channel and out. The slide may be provided in addition to or alternatively from the spring/button implementation.

Turning to FIG. 4C (and as also shown in FIGS. 1A-1B), an additional component that may be used in certain example embodiments is a dust cover 404 that may slide into cover channel 236. The dust cover 404 may be arranged so as to rotate between an open and closed position while disposed in the cover channel 236. The dust cover 404 may assist in keeping outside elements (e.g., dust and the like) from falling into slot 240 and make the overall appearance of power system 100 more aesthetically pleasing. The dust cover 404 may be constructed out of molded plastic (e.g., ABS) or metal such as aluminum. In certain example embodiments, having the dust cover 404 in place may still allow for longitudinal movement of a power receptacle along the length of the power strip. In certain example embodiments, the dust cover 404 may rest on the power receptacle 300 or there may be a small air gap between the resting closed position of the dust cover 404 and an inserted power receptacle 300.

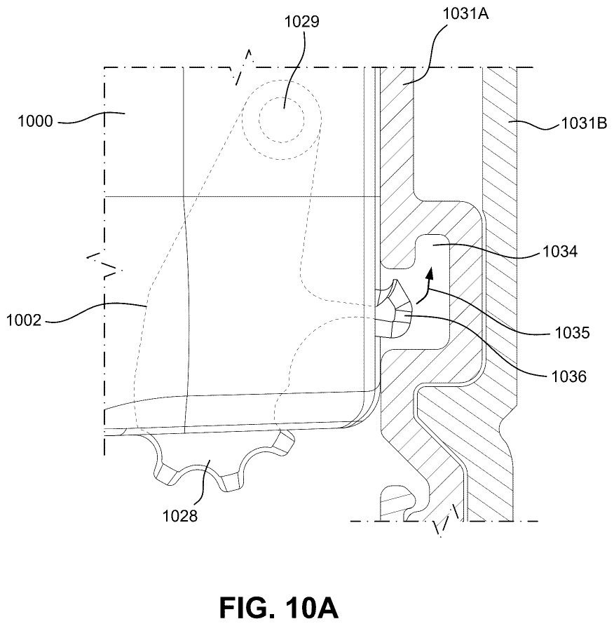

FIG. 9 is a side view showing another example of a dust cover 902 according to certain example embodiments. Dust cover 902 may be used instead of dust cover 404 in certain examples. In some examples, dust cover 902 may be formed out of a flexible material that holds its shape. For example, the material of the dust cover 902 may retain its memory and thereby allow it to spring back to be parallel with the top of the power strip. In some examples, the top portion of dust cover 902 may be bendable to allow a power receptacle to be inserted into a slot of a power strip. In certain examples, the dust cover 902 may be an extruded strip that can be peeled back slightly prior to inserting a power receptacle into the power strip.

In certain example embodiments, the depth of a power receptacle (including or excluding the arm) may be greater than the depth of the power strip.

In certain example embodiments, the depth of the lock of the power receptacle may be less than the distance between the arm and the back surface of the power receptacle.

### Description of FIGS. 5-7: GFCI Module

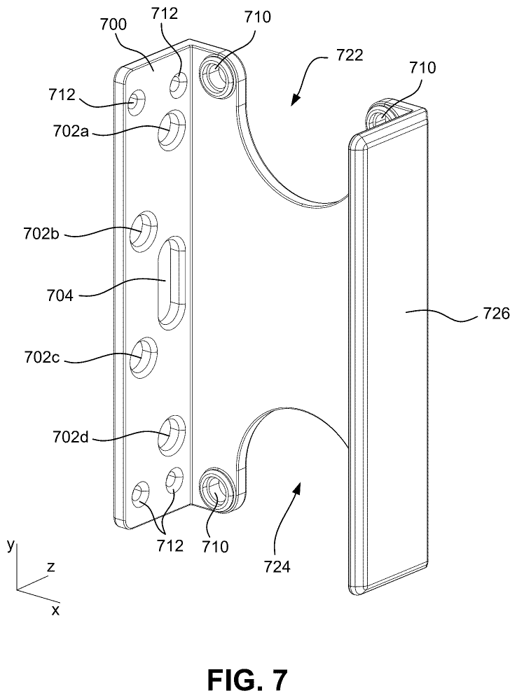

FIG. 5 is an exploded view of the GFCI module shown in FIG. 1 and a bracket 700 that can be used to couple the GFCI module to a power strip according to certain example embodiments. FIG. 6 is a perspective view of the GFCI module shown in FIG. 5 according to certain example embodiments. FIG. 7 is a perspective view of the bracket used to mount the GFCI module of FIG. 6 to a power strip according to certain example embodiments.

More modern electrical codes in the US (and elsewhere) require ground-fault circuit interrupter (GFCI) for power outlets located in certain sections of the home (e.g., bathrooms, kitchens, etc.). Typically, GFCI is built into the outlet that is provided at the fixed location. The GFCI is a circuit breaker that is configured to shut off electrical power in the event of a ground fault. The GFCI operates by detecting the incoming and outgoing current from the circuit and ensuring that the current matches (in opposing directions). If it does not match, the circuit breaker is tripped, and power is terminated for the circuit.

According to certain example embodiments, the power system 100 may be provided with a GFCI module 500 that is external and separate from the individual receptacles that are disposed on the power strip 200. In other words, the GFCI module 500 may provide the GFCI functionality for all of the power system 100—and not just individual receptacles thereof.

GFCI module 500 includes a ground fault circuit interrupter, a first knockout panel (which may also be called an access panel) 520 provided on the bottom section, and a second knockout panel 522 provided on the back of the GFCI module. These knockouts allow for connecting external wires (e.g., romex) to the GFCI module 500 from an external power source. Connections may be provided in the form of a hardwire or via plugin.

GFCI module 500 includes three electrical terminals on each side of the GFCI module. As shown in FIG. 5, on the left side, are connections 510A, 512A, and 514A. As shown in FIG. 6, on the right side, are connections 510B, 512B, and 514B. The connections allow connection of a power strip(s) on the left, the right, or both the left and right.

For example, connection between terminals 510A, 512A, 514A, 510B, 512B, and 514B and corresponding first conductor 252a, second conductor 252b, and third conductor 252c of the power strip 200 may be provided via a male-to-male electrical connector 516A, 516B, and 516C that may be inserted into first conductor 252a, second conductor 252b, and/or third conductor 252c and then correspondingly inserted into 510A, 512A, 514A, 510B, 512B, and/or 514B.

Turning to FIG. 6, the GFCI module 500 includes a front plate 540 with a reset button 530 and a test button 532 for GFCI functionality. Also included is an indicator light 534 for the GFCI functionality. As shown, there is no electrical outlet included on the front plate 540. Indeed, the GFCI module 500 can be designed without an electrical socket, such as found on power receptacle 300 (or similar).

The GFCI module 500 may be secured to power strip and/or a wall (or other surface) through the use of GFCI bracket 700 that is shown in FIGS. 5 and 7.

GFCI bracket 700 includes a first side with a plurality of holes, and a second side that does not include holes. On the first side, the GFCI bracket 700 includes holes 702A and 702D configured to correspond to holes 510A and 510B of the GFCI module. Holes 702B and 702C are configured to correspond to holes 512A and 512B of the GFCI module. And hole 704 is configured to correspond to the location of holes 514A and 514B. The first side also includes screw/fastener holes 712 for structurally connecting the bracket to the power strip 200. For example, screws can be used to screw/attach the bracket 700 to a power strip. The GFCI module may then be attached/screwed to the bracket 700. Bolt holes 710 are provided in the back of the bracket for security the GFCI bracket 700 to a wall.

GFCI bracket includes opposing cutouts 722 and 724 that may be shaped to accept a modular romex connection (e.g. ½ inch, ¾ inch, etc.). Note that the opposing cutouts allow the bracket 700 to be flipped lengthwise and thus to allow connection of the power strip on either the left or right side of the GFCI module.

In other examples, the bracket may include holes on both sides and thus allow connections on the GFCI module from both the left and right. An example of this type of setup is shown in FIG. 1B.

It will be appreciated that using a bracket to secure the GFCI module may provide increased safety over hardwiring or securing the GFCI module directly.

### Description of FIGS. 8A-8B: Angled Power Receptacle

FIG. 8A shows a front view of an angled power receptacle according to certain example embodiments. FIG. 8B is a side view of the power receptacle shown in FIG. 8A.

An example power receptacle 800 that is insertable into a power strip may include an angled face 802 and an angled socket 803. These may be angled away from the main body 804 of the power receptacle by an angle 806. Angle 806 may be anywhere between 0 and 45 degrees. As noted herein, different angles may be provided in connection with different example embodiments. For example, a first example power receptacle may have an angle of 20 degrees and a second example power receptacle may have an angle of 45 degrees. These different angled versions may each be connectable/insertable into a given power strip to allow different angles to be used to connect electrical components to the power strip.

Another example of a latch or lock that may be included in an example power receptacle is shown in FIGS. 8A and 8B. Here, power receptacle 800 includes a latch 810 that is structurally connected to arm 812. Arm 812 is configured to be moved forward and backwards (e.g., anteroposterior movement), which causes the latch 810 to move into an out of a locking position in which the latch 810 can be locked to a channel of a power strip (e.g., channel 234). In other words, unlike button 328 that is configured to move into the body of the power receptacle and thereby cause a lock to move, arm 812 is configured to be moved towards the front face/away from the front face in order to cause latch 810 to engage with a channel and lock the power receptacle into place on a power strip. Additionally details of an example latch are discussed below.

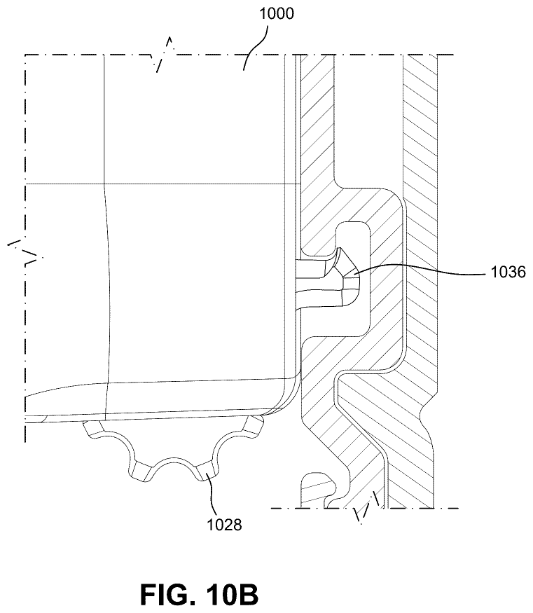

### Description of FIGS. 10A-10B: Latch

FIGS. 10A and 10B are side views of an example locking element according to certain example embodiments, such as with power receptacle 800 or power receptacle 300, or the like. FIG. 10A shows the locking element before being latched to a power strip and FIG. 10B shows the locking element after the latch has been locked to a power strip (e.g., moved into a locking position).

Locking element 1002 includes an arm 1028, latch 1036, and a joint 1029. Locking element 1002 may be disposed within a power receptacle 1000. Power receptacle 1000 is an example of any of the power receptacles discussed herein. FIG. 10A shows the locking element 1002 in an unlocked position in which the arm 1028 is positioned towards a front face of the power receptacle 1000. As shown in FIG. 10A, latch 1036 may extend away from a rear face of the power receptacle when locking element 1002 is in an unlocked position. In other examples, the latch may be entirely retractable into the body of the power receptacle when in an unlocked position.

Latch 1036 is structurally connected to arm 1028 such that movement (e.g., anteroposterior movement) of arm 1028 causes the locking element 1002 to pivot and move latch 1036 along path 1035. FIG. 10B shows the locking element 1002 in a locked position in which the arm 1028 has been pushed towards a rear face of the power receptacle 1000.

More specifically, when power receptacle 1000 is engaged with a power strip, the latch 1036 is configured to move along path 1035 and into a recessed portion 1034 of a locking channel of the power strip. This allows the power receptacle 1000 to be positioned (e.g., securely) on a power strip and be used to supply power via a socket provided thereon.

Note that in the example shown in FIGS. 10A-10B, the locking channel of the power strip includes recessed area 1034 that allows the latch 1036 to be more firmly secured (as shown in FIG. 10B). This is due to the addition of a lip at the end of the latch 1036 that engages into the recessed area 1034. The recessed area 1034 may be formed out of housing element 1031A (which may correspond to housing element 231A) that is connected to housing element 1031B (which may correspond to housing element 231B). The lip on the latch 1036 can act to limit pull force onto the power receptacle when the locking mechanism 1002 is engaged with the power strip.

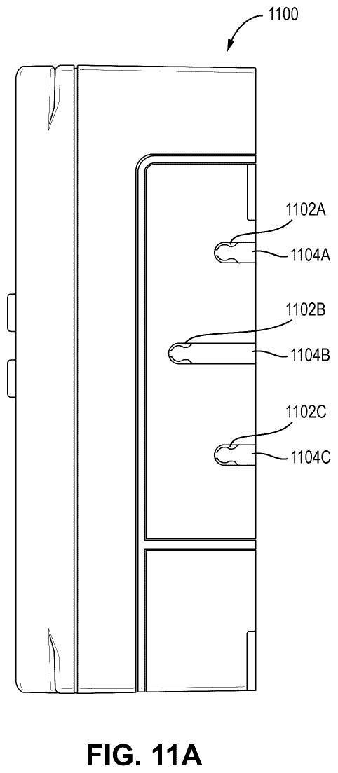

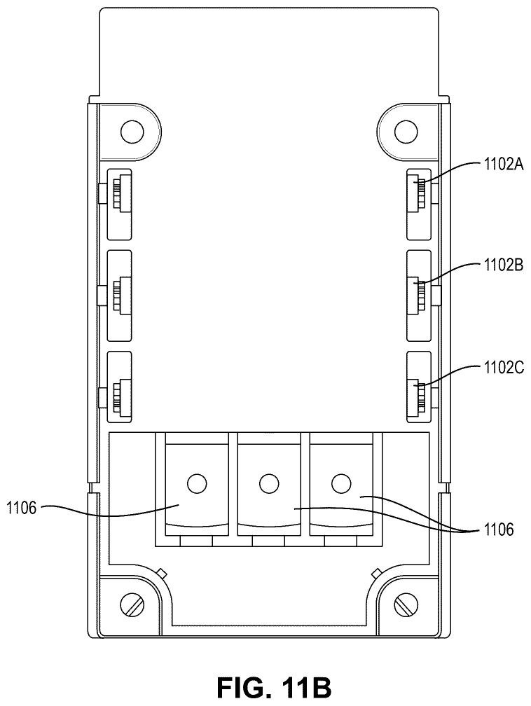

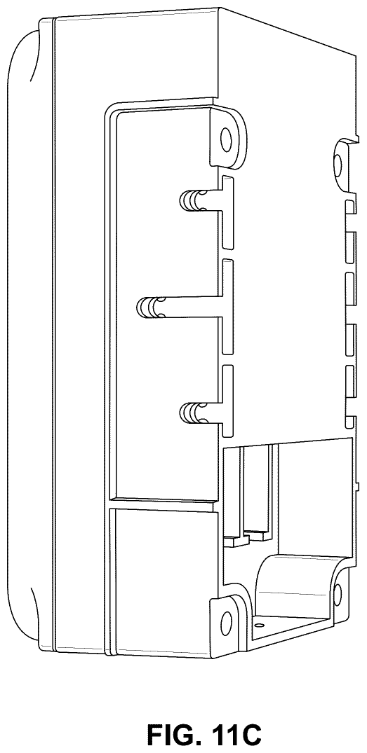

### Description of FIGS. 11A-14: GFCI Module

FIG. 11A is a side view of another example of a GFCI module according to certain example embodiments; FIG. 11B is a rear view and FIG. 11C is a rear-perspective view of the GFCI module shown in FIG. 11A.

GFCI module 1100 may be used instead of, or along with, GFCI module 500 in connection with the embodiments discussed herein. GFCI module 1100 may include any or all of the features of GFCI module 500.

GFCI module 1100 includes three grooves (e.g., channels, etc.) 1104A, 1104B, and 1104C. Each of the grooves is dimensioned to accept electrical pins or connections (e.g., 516A, 516B, 516C, 1204A, 1204B, 1204C) that extend from a power strip. At the end of each of the grooves are electrical latches 1102A, 1102B, and 1102C that each connect to ground, neutral, and hot wires of electrical terminals 1106 (e.g., via internal wiring of the GFCI module). In certain examples, the electrical latches 1102A, 1102B, and 1102C are located within GFCI module 1100 such that a person's finger cannot accidentally come into contact with latches 1102A, 1102B, and 1102C. In other words, grooves 1104A, 1104B, and 1104C are dimensioned to be just wide enough to accept electrical connections 1204A, 1204B, 1204C, but narrow enough to not allow the finger of a person to be inserted into the channel and come into contact with latches 1102A, 1102B, or 1102C.

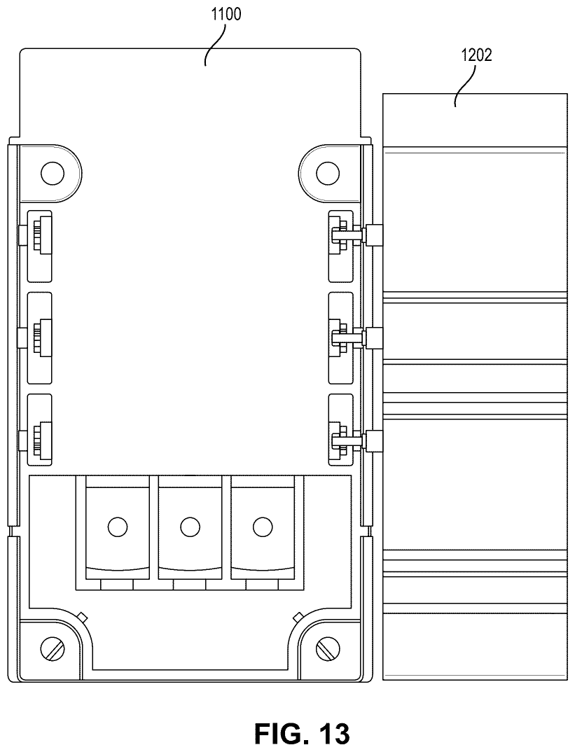

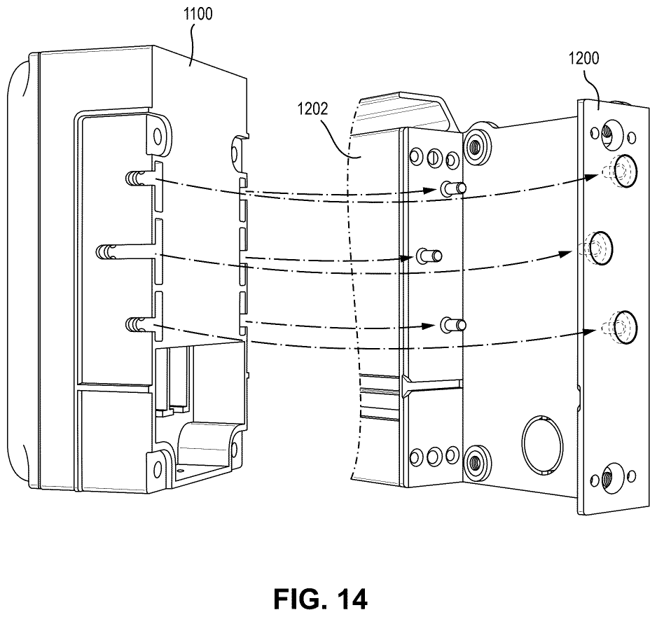

. In some examples, electrical latches 1102A, 1102B, and 1102C are movable to allow electrical connections to be pressed into the electrical latches 1102A, 1102B, and 1102C (as shown in FIG. 13). In certain example embodiments, electrical latches of the GFCI module are attached via a spring that biases the latch. The spring may thereby cause a force to be applied to an electrical connections that come into contact with the latches. The movement of electrical latches 1102A, 1102B, and 1102C allows an example GFCI module to be snapped over electrical connections (e.g., male pins) that extend from a power strip (e.g., installed within a power strip). The result connection of a GFCI module to a power strip is shown in FIGS. 13 and 14.

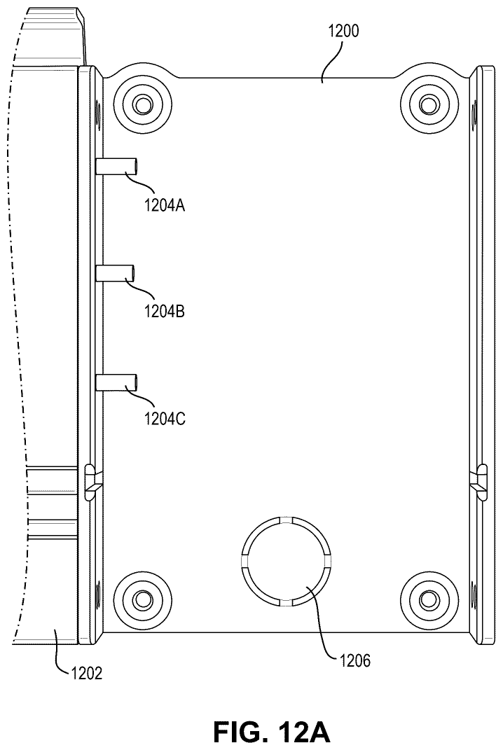

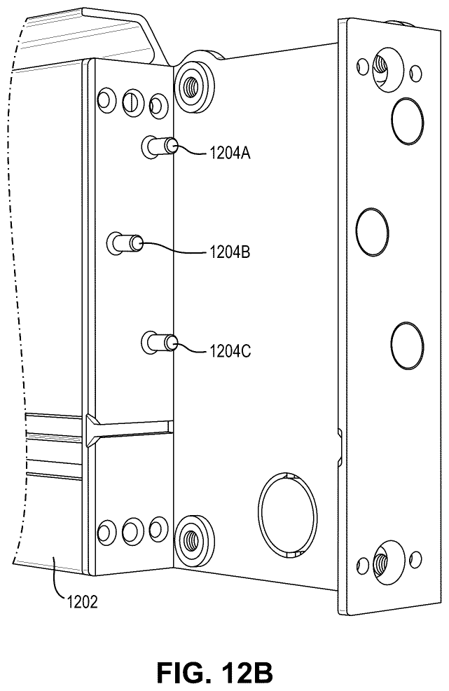

Turning now to FIGS. 12A and 12B, views of an example bracket 1200 connected to an example power strip 1202 according to certain example embodiments are shown. Bracket 1200 may be the same or similar to bracket 700 (note that the arrangement of the holes in the bracket may be symmetrical for bracket 1200). In FIG. 12A, bracket 1200 is shown and connected to a power strip 1202 with electrical connections 1204A, 1204B, 1204C extending from electrical conductors (e.g., 252a, 252b, and 252c) of a power strip and through holes in bracket 1200. Bracket 1200 also includes a knockout 1206 that may be dimensioned to fit an appropriate electrical connector (e.g., a ⅜ inch romex connector).

FIG. 13 is a rear view illustrating the example GFCI module 1100 from FIG. 11B connected to a power strip 1202 according to certain example embodiments. Note that this view does not include a bracket. FIG. 14 shows a perspective view of the example GFCI module from FIG. 11A in combination with the bracket and power strip from FIG. 12A according to certain example embodiments. As shown in FIG. 14, the GFCI module 1100 may be pushed into place into bracket 1200 to thereby connect the GFCI module 1100 to electrical connections extending from power strip 1202.

For installation, the power strip 1202 may be installed (e.g., onto a wall or other surface) and then then bracket 1200 installed. Alternatively, the bracket 1200 may be installed followed by the power strip 1202. Electrical connections (male-to-male pins) may then be placed through holes in the bracket to connect to electrical conductors of the power strip. With the electrical connections in place, the GFCI module 1100 may then be installed into the bracket by pressing it into the bracket and allowing the electrical connections to pass through channels of the GFCI module until coming into contact with the electrical latches of the GFCI module 1100.

In certain example embodiments, an example GFCI module is keyed to only slide into a bracket in one orientation. In certain example embodiments, an example GFCI module includes a perimeter ridge to prevents dust/debris entry into the channels when the GFCI is installed/mounted.

In certain example embodiments, the mounting bracket may include unthreaded through holes. In some examples, plastic or rubber plugs may be inserted into the through holes when there is no power strip on a given side of the bracket (e.g., if a power strip is on one side of the bracket, but not the other).

### Selected Terminology

The elements described in this document include actions, features, components, items, attributes, and other terms. Whenever it is described in this document that a given element is present in “some embodiments,” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim element is expressly recited using the phrase “means for” or “step for.”

### Additional Applications of Described Subject Matter

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A modular electrical power system comprising:
a power rail that includes at least two electrical conductors extending in a longitudinal direction of the power rail, the power rail defining a first channel that is transverse to the longitudinal direction, and a second channel that is also transverse to the longitudinal direction;
at least one power receptacle that is configured to engage with, and be removable from, the power rail, the at least one power receptacle including:
a front face with an electrical socket that is configured to electrically couple to the at least two electrical conductors when the power receptacle is engaged with the power rail,
a structural arm configured to, when the power receptacle is engaged with the power rail, engage with the first channel, and
at least one protrusion configured to move between extended and retracted positions, and when in the extended position configured to engage the channel while the structural arm is engaged with the first channel.

2. The modular electrical power system of claim 1, wherein the at least one power receptacle is movable in the longitudinal direction without decoupling from the power rail, wherein the electrical socket remains electrically coupled to the at least two electrical conductors when the power receptacle is engaged with the power rail.

3. The modular electrical power system of claim 1, wherein the electrical socket of the power receptacle is positioned below a top surface of the power rail that includes a gap in which the arm of the power receptacle engages with the first channel.

4. The modular electrical power system of claim 1, wherein the power receptacle includes a button that is configured to, when actuated, cause the at least one protrusion to move between the extended and retracted positions.

5. The modular electrical power system of claim 1, wherein the power receptacle includes a locking element that includes a locking arm and a locking latch, wherein the locking arm is movable in a direction that is transverse to the front face that includes the electrical socket and causes the locking latch to swing into a locking position.

6. The modular electrical power system of claim 1, wherein the at least two electrical conductors includes at least three electrical conductors, wherein one of the three electrical conductors is disposed along a first side wall of the first channel, and two of the at least three electrical conductors are disposed along a second side wall of the first channel that is opposite the first side wall, wherein the electrical conductors are hollow.

7. The modular electrical power system of claim 1, further comprising:
a removably attachable cover configured to attach to the power rail and cover the structural arm that is engaged with the first channel.

8. The modular electrical power system of claim 7, wherein, with the cover attached to the power rail and covering the structural arm that is engaged with the first channel, the at least one power receptacle is movable in the longitudinal direction without decoupling from the power rail, wherein the electrical socket remains electrically coupled to the at least two electrical conductors when the power receptacle is engaged with the power rail.

9. The modular electrical power system of claim 1, further comprising:
a GFCI module that includes:
a housing;
a ground-fault circuit interrupter,
a front face of the housing with at least one button therein,
three terminals that are electrically connected to the ground-fault circuit interrupter, the three terminals along a second face of the housing that is transverse to the front face, the three terminals configured to be electrically coupled to the at least two electrical conductors of the power rail.

10. The modular electrical power system of claim 9,
wherein the GFCI module includes a second set of three terminals along a third face of the housing, wherein the second set of three terminals are configured to electrically couple to conductors of a second power rail.

11. A power receptacle adapted to be secured to a power rail, the power receptacle comprising:
a front face with a three pronged electrical socket;
a structural arm including three electrical contacts, the structural arm including an inner face and an outer face, with two of the three electrical contacts disposed on one of the inner and outer face, and the other one of the three electrical contact disposed on the other one of the inner and outer face, each of the three electrical contacts electrically coupled to the electrical socket, the structural arm configured to, when the power receptacle is engaged with the power rail, slot into a channel of the power rail; and
at least one protrusion configured to move between extended and retracted positions, and when in the extended position configured to structurally engage with the power rail.

12. The power receptacle of claim 11, further comprising:
a main body on which the front face is disposed, wherein the arm structurally connects to the main body, wherein a back face of the main body is separated from the inner face of the arm such that the power rail is position therebetween when engaged with the power receptacle.

13. The power receptacle of claim 11, further comprising:
a movable member that is configured to, when actuated, cause the at least one protrusion to retract and structurally release from the power rail.

14. A modular ground fault circuit interrupter (GFCI) module that is adapted to be connected to a power rail that supplies power to one or more electrical sockets, the modular GFCI module comprising:
a housing that includes a front face and a second face that is transverse to the front face, the housing including circuitry for a ground fault circuit interrupter;
at least one button disposed in the front face of the housing; and
three terminals that are each configured to be electrically coupled to a corresponding electrical conductor of a power rail, wherein the three terminals are disposed along the second face of the housing.

15. The GFCI module of claim 14, further comprising:
a second set of three terminals that are each configured to be electrically coupled to a corresponding electrical conductor of a second power rail,
wherein the housing includes a third face that is also transverse to the front face and on an opposite side of the housing form the second face, wherein the second set of three terminals are disposed along the third face of the housing.

16. The GFCI module of claim 15, wherein the GFCI module is configured to be simultaneously electrically connected to both the power rail and the second power rail and supply, in connection with the circuitry for the ground fault circuit interrupter, alternating current power thereto.

17. The GFCI module of claim 14, further comprising:
a bracket in which the housing is configured to be disposed, the bracket having a back panel, which is opposite the front face of the housing, and two opposing side panels that are each transverse to the back panel.
wherein one of the two side panels includes a plurality of apertures through which electrical pins connect to corresponding electrical conductors of the power rail to the three terminals,
wherein the other one of the two side panels includes no apertures.

18. The GFCI module of claim 14, wherein the GFCI module does not include an electrical socket.

19. The GFCI module of claim 14, wherein the housing includes a plurality of grooves along the second face, wherein each of the plurality of grooves corresponds to one of the three terminals.

20. The GFCI module of claim 19, further comprising:
a plurality springs that are each coupled to a respective one of the three terminals, each of the plurality of springs biasing a respective terminal to latch onto the corresponding electrical conductor of the power rail when the GFCI module is installed to the power rail.
